(19) United States
(12) Patent Application Publication
(10) Pub. No.: US 2007/0059418 A1
(43) Pub. Date: Mar. 15, 2007

(54) Self-mixing tabletop sweetener

(76) Inventors: Steven J. Catani, Athens, GA (US); Shyhyuan Liao, West Windsor, NJ (US); Melanie Loades, Surrey (GB)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/225,239

(22) Filed: Sep. 13, 2005

(51) Int. Cl. A23L 1/236

(52) U.S. Cl. 426/548

(57) ABSTRACT

Self-mixing compositions containing an effective amount of sweetener and a gas-releasing system are provided. Methods of making such compositions and methods of using such compositions to provide, e.g., sweetness to an aqueous foodstuff are also provided.

### FIELD OF THE INVENTION

The present invention relates to self-mixing compositions containing an effective amount of a sweetener and a gas-releasing system. More particularly, the present invention relates to self-mixing compositions wherein the gas-releasing system contains a carbonate and/or bicarbonate and an acid. Methods of making such compositions and methods of using such compositions to provide, e.g., sweetness to a beverage or ingestible liquid are also provided.

### BACKGROUND OF THE INVENTION

People often customize the taste of food and beverages by adding sweeteners thereto. For example, sweeteners are added to beverages, such as, coffee and tea; on cereals; on fruit; as toppings on baked goods; and in many other ways. Sweetening a food or beverage alters its flavor and usually increases its appeal. This behavior is found in all cultures, but is especially prevalent in western cultures.

The most common sweeteners are nutritive sweeteners. Nutritive sweeteners not only provide sweetness, but are also absorbable into the bloodstream and may be metabolized to provide energy for immediate use or for storage as fat. Nutritive sweeteners are typically extracted from plants that produce them in various quantities and for various purposes. For example, sucrose, a nutritive sweetener in wide spread use, is produced from many sources, e.g., sugar cane and sugar beet roots.

Sugar alcohols are another form of sweetener. Sugar alcohols are chemically alcohols, but are derived from sugar molecules. Sugar alcohols vary in sweetness from about half as sweet to about as sweet as sucrose. Accordingly, sugar alcohols may be used in place of sugar. Sugar alcohols have about one-half to three-quarters the amount of calories of sugar on a per weight basis. Sugar alcohols are slowly and incompletely absorbed from the small intestine into the blood. Absorbed sugar alcohols are converted to energy by processes that require little or no insulin. Accordingly, these sweeteners may be used by diabetics or those on low-carbohydrate diets.

High intensity sweeteners are well known alternatives to nutritive sweeteners. High intensity sweeteners provide sweetness without the calories and other metabolic impacts of the nutritive sweeteners. In many cases, high intensity sweeteners provide a sweet flavor that is preferred to, e.g., nutritive sweeteners. Some high intensity sweeteners, such as, aspartame, are nutritive, but are so intense that they still provide negligible calories because very small amounts are required. Other high intensity sweeteners, such as, sucralose, are not absorbed when ingested and are, therefore, non-nutritive sweeteners.

Sweeteners are available in many delivery forms. Granular formulations may be designed to provide sweetness on a spoon-for-spoon basis with sucrose. Granular formulations may be stored in small packets or sachets, generally holding one or two teaspoon equivalents of sucrose sweetness. Sweeteners are also available in tablet form, each tablet generally containing one or two teaspoon equivalents of sucrose sweetness. Liquid drops of sweeteners are also available, each of which being calibrated to deliver sweetness equivalent to one or more teaspoons of sucrose. Other sweetener forms are also known, such as, for example, cubes, sprays, powders, and various other forms. Each delivery form has its advantages and disadvantages for sweetness sensory improvement.

Tablets, are a popular consumer form for sweetener delivery especially to aqueous foodstuffs, such as, beverages. In some markets, specifically the United Kingdom and Australian markets, tablets command the highest market share of all the delivery forms of sweeteners. Tablets are currently available containing sweeteners including aspartame, acesulfame, saccharine, sucralose, as well as, some of the protein based sweeteners, such as, stevia.

Commercially available tablets are produced using conventional tabulating equipment and formulation technology well-known to those skilled in the art. Tablets have several advantages as a delivery vehicle. For example, tablets are small and easy to carry or store in a large quantity. This is of particular advantage if the sweeteners are used for portable delivery (i.e., carried by a user to assure that their particular sweetener choice is available when they want it). Tablets also contain a unit dose, typically one or two equivalent doses of sucrose sweetness, which facilitates sweetening without the need for measuring equipment.

Further, tablets lend themselves easily to dispensers, keeping the sweetener isolated from environmental contaminants prior to use and eliminating the need to touch the sweetener to place it in the product to be sweetened. This is important where the sweetener will be used by several individuals.

Despite these benefits, tablets have several drawbacks. For example, tablets do not readily dissolve or distribute the sweetener evenly throughout a foodstuff, such as, for example, a beverage. Currently available tablets generally drop to the bottom of a beverage and slowly dissolve. This may take from ten seconds to up to a few minutes in cold beverages. Even after completely dissolved, the sweetness is typically not evenly distributed in the beverage. These drawbacks may be overcome by stirring with a stirring device, e.g., a spoon or swizzle stick, or by swirling the foodstuff within a container. Stirring requires that a stirring device be available, defeating the portability advantage, and requires post-sweetening clean up or disposal of the device. For disposable stirring devices, an additional drawback is the environmental impact of disposing of such a device. Swirling, e.g., the beverage container, may be used to distribute the sweetener, but requires careful control to avoid spillage. Leaving the necessary space to accomplish such swirling also wastes headroom in the beverage container.

It would, therefore, be advantageous to provide a sweetener composition that incorporates the best of all previous products. In particular, it would be advantageous to provide a sweetener composition in tablet, cube, or other solid dosage form that dissolves quickly and distributes the sweetener in a foodstuff, e.g., a beverage, without the need for stirring devices or other manual manipulations.

### SUMMARY OF THE INVENTION

One embodiment of the invention is a self-mixing composition comprising, consisting of, and/or consisting essentially of an effective amount of a sweetener and a gas-releasing system.

Another embodiment is a tablet comprising, consisting of, and/or consisting essentially of one of the compositions of the present invention.

A further embodiment of the present invention is a self-mixing composition. This composition comprises, consisting of, and/or consisting essentially of about 40% sodium bicarbonate by weight based on the total weight of the composition, about 40% of at least one acid by weight based on the total weight of the composition, about 8% of at least one flavor by weight based on the total weight of the composition, about 11.5% leucine by weight based on the total weight of the composition, and about 0.5% sweetener by weight based on the total weight of the composition.

A further embodiment of the present invention is a method of making a sweetener composition. This method comprises, consisting of, and/or consisting essentially of combining an effective amount of a sweetener with a gas-releasing system.

Another embodiment of the present invention is a method of dispersing a composition in an aqueous foodstuff. This method comprises contacting the aqueous foodstuff with a composition comprising, consisting of, and/or consisting essentially of a sweetener and a gas-releasing system.

### DETAILED DESCRIPTION OF THE INVENTION

The present invention relates to U.S. application Ser. No.______, entitled “SWEETENER AND AROMA COMPOSITIONS”, and U.S. application Ser. No. ______, entitled “HIGH INTENSITY SWEETENERS AND COLORING AGENT COMPOSITIONS,” which were filed on Sep. 13, 2005, and are hereby incorporated by reference as if recited in full herein.

As used herein, all numerical ranges provided are intended to expressly include at least all numbers that fall between the endpoints of ranges.

Unexpectedly and surprisingly, it has been discovered that by adding a gas-release system to a sweetener composition, such a composition when placed in an aqueous foodstuff releases sufficient amounts of gas (i.e., “fizz”) to disperse the components of the composition, e.g., sweetener, throughout the foodstuff. The released gas causes the rest of the components of, e.g., a tablet or cube, to float to the top and begin dissolving and dispersing throughout the foodstuff. This action of the gas both increases the speed of dissolution and evenly disperses the sweetener in the liquid. Therefore, the sweetener composition of the present invention provides a means to add a sweetener to a foodstuff, e.g., a beverage, or an ingestible liquid without the need for any additional mixing. The sweetener composition of the present invention produces sweetness and a mildly carbonated, acidic final product when added to, e.g., a beverage or ingestible liquid.

As used herein, unless otherwise indicated, the term “effective amount” refers to (1) the amount of, e.g., a sweetener containing composition that provides a sweet taste or masks a bitter taste in a foodstuff and/or (2) the amount of the gas-releasing system that is sufficient to disperse the composition in a foodstuff. Preferably, the effective amount of sweetener is greater than that provides more than about 0.5 teaspoons of sucrose equivalent sweetness to an aqueous foodstuff.

As used herein, unless otherwise indicated, the term “foodstuff” means any edible material to which a composition of the present invention may be added. Foodstuffs useful in the present invention include, for example, aqueous foods, such as, for example, cake and cookie mixes, beverages. Non-limiting examples of beverages useful in the present invention include coffee, tea, milk, seltzer, unsweetened drinks, and the like.

As used herein, unless otherwise indicated, the term “sweetener” is any food-grade material that produces a sweet taste when consumed and is deemed safe for human consumption. A “food-grade material” for purposes of the present invention is a material that is safe for use in an aqueous food or beverage that will be consumed by a human (or animal). Standards for determining whether materials are safe for human consumption are set forth in the Codex Alimentarius produced by the World Health Organization (1999), which is incorporated by reference herein as if recited in full.

As used herein, unless otherwise indicated, the term “sweetener” includes nutritive sweeteners, non-nutritive sweeteners, and high intensity sweeteners. As used herein, unless otherwise indicated, the term “high intensity sweetener” means a food-grade material that provides a high sweetness per unit mass as compared to a nutritive sweetener and provides little or no nutritive value.

Examples of sweeteners useful in the present invention include, for example, sucralose, sucrose, fructose, tagatose, glucose, sugar alcohols, aspartame, acesulfame, saccharine, cyclamate, neotame, brazzein, stevia, salts, derivatives, and combinations thereof. A preferred high intensity sweetener is sucralose.

As used herein, unless otherwise indicated, the term “sugar alcohol” means a food-grade alcohol derived from a sugar molecule. Sugar alcohols useful in the present invention include, for example, mannitol, sorbitol, lactitol, isomalt, erythritol, xylitol, maltitol, hydrogenated isomaltulose, hydrogenated starch hydrolyzates, and combinations thereof.

Sweetener intensity may be assessed by determining the amount of the sweetener required to provide sweetness comparable to a predetermined mass of a nutritive sugar, e.g., sucrose. In the present invention, this parameter is expressed in terms of “sucrose equivalent sweetness.” For example, if a sweetener is twice as intense as sucrose, 0.5 g of the sweetener would equal one gram of sucrose equivalent sweetness. Thus, the amount of a sweetener according to the present invention, e.g., a high intensity sweetener in a tablet, may provide the sweetness equivalent of one or two teaspoons of sucrose, or any other unit amount. The sweetener may also be matched to a specific application, such as, for example, a beverage or an orally administered medicine.

The compositions of the present invention are available in various forms, including tablets, powders, cubes, and granules. When in a tablet form, the gas-releasing system may be distributed asymmetrically within the tablet or other dosage form. This causes the tablet, cube, or other solid dosage form to move or rotate as the gas is released enhancing the mixing action.

The compositions of the present invention may contain one or more food-grade additives. Food-grade additives useful in the present invention include, for example, food-grade flavors, texture enhancers, coloring agents (e.g., dyes), bulking agents, aroma components, binders, and combinations thereof.

As used herein, unless otherwise indicated, the term “flavor” means any food-grade material that may be added to the present compositions to provide a desired flavor to a foodstuff. Flavors useful in the present invention include, for example, cream, hazelnut, vanilla, chocolate, cinnamon, pecan, lemon, lime, raspberry, peach, mango, vanillin, butter, butterscotch, tea, orange, tangerine, caramel, strawberry, banana, grape, plum, cherry, blueberry, pineapple, elderberry, watermelon, bubblegum, cantaloupe, guava, kiwi, papaya, coconut, mint, spearmint, derivatives, and combinations thereof.

As used herein, unless otherwise indicated, the term “texture enhancer” means any food-grade material that may be added to the present compositions to provide a desired texture to a foodstuff. Texture enhancers useful in the present invention include, for example, guar gum, alginate, taro gum, gellan gum, xanthium gum, amalose, amalopectin, konjac, salts, derivatives, and combinations thereof.

As used herein, unless otherwise indicated, the term “coloring agent” means any substance that may be employed to produce a desired color in a foodstuff or other composition. Such coloring agents are approved for human consumption pursuant an appropriate governmental agency and/or act, such as, the Food and Drug Administration (FDA)/Federal Food Drug and Cosmetic Act (FD&C) in the United States or an analogous agency of the European Union. For example, the coloring agent may be a food-grade dye or a lake. In the present invention, a “dye” is a water soluble compound, which is available as a powder, granule, liquid or other special purpose form. Dyes are typically used in beverages, dry mixes, baked goods, confections, dairy products, pet foods, and a variety of other products. A “lake” is a water insoluble form of a dye. Typically, lakes are more stable than dyes and are ideal for coloring products containing fats and oils or items lacking sufficient moisture to dissolve dyes. Lakes are typically used in coated tablets, cake and donut mixes, hard candies, and chewing gums.

Coloring agents useful in the present invention include, for example, FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof. Preferred coloring agents according to the present invention are FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), and combinations thereof.

In the present invention, the combination of color and agitation caused by the gas-releasing system enhances the sensory experience of, e.g., a consumer, such as, a child. Multiple color agents may be added to the compositions of the present invention.

As used herein, unless otherwise indicated, the term “bulking agent” means any food-grade material that may be added to the present compositions to increase the bulk of the composition without significantly increasing the calories contained in or the sweetness delivered by the composition. For example, bulking agents may be used to increase the volume of a composition of the present invention (e.g., when the sweetener is a high intensity sweetener) for convenience in, e.g., accurately measuring and dispensing such compositions. Bulking agents useful in the present invention include, for example, maltodextrin, fructo-oligosaccharide, polydextrose, inulin, fibersol, high amylase carbohydrates, resistant starches, derivatives, and combinations thereof. A preferred bulking agent useful in the present invention is maltodextrin.

As used herein, unless otherwise indicated, the term “aroma component”means any food-grade volatile substance that may be employed to produce a desired scent, for example, when mixed with a foodstuff. Aromas useful in the present invention include, for example, essential oils (citrus oil), expressed oils (orange oil), distilled oils (rose oil), extracts (fruits), anethole (liquorice, anise seed, ouzo, fennel), anisole (anise seed), benzaldehyde (marzipan, almond), benzyl alcohol (marzipan, almond), camphor (cinnamomum camphora), cinnamaldehyde (cinnamon), citral (citronella oil, lemon oil), d-limonene (orange) ethyl butanoate (pineapple), eugenol (clove oil), furaneol (strawberry), furfural (caramel), linalool (coriander, rose wood), menthol (peppermint), methyl butanoate (apple, pineapple), methyl salicylate (oil of wintergreen), neral (orange flowers), nerolin (orange flowers), pentyl butanoate (pear, apricot), pentyl pentanoate (apple, pineapple), sotolon (maple syrup, curry, fennugreek), strawberry ketone (strawberry), substituted pyrazines, e.g., 2-ethoxy-3-isopropylpyrazine; 2-methoxy-3-sec-butylpyrazine; and 2-methoxy-3-methylpyrazine (toasted seeds of fenugreek, cumin, and coriander), thujone juniper, common sage, Nootka cypress, and wormwood), thymol (camphor-like), trimethylamine (fish), vanillin (vanilla), and combinations thereof. Preferred aroma components according to the present invention include, essential oils (citrus oil), expressed oils (orange oil), distilled oils (rose oil), extracts (fruits), benzaldehyde, d-limonene, furfural, menthol, methyl butanoate, pentyl butanoate, salts, derivatives, and combinations thereof.

The aroma component may be present in any amount in the composition. Preferably, the aroma component is present in an amount from about 2- to about 10-times the detectable amount. More preferably, the aroma component is present in an amount from about 2- to about 5-times the detectable amount. As used herein, unless otherwise indicated, the term “detectable amount” is the amount of the aroma component required to produce a scent detectable in the foodstuff. The gas-releasing system of the present invention enhances the sensory experience by releasing and dispersing the aroma component(s).

As used herein, unless otherwise indicated, the term “binder” refers to any food-grade material that is suitable for facilitating the pressing and formation of tablets. The selection of an appropriate binder is not critical and embraces any conventional binder so long as the binder does not substantially interfere with the self-mixing or the organoleptic properties of the foodstuff. Non-limiting examples of suitable binders useful in the present invention, include microcrystalline cellulose, gum tragacanth, gelatin, leucine, lactose, and combinations thereof. Preferably, the binder, if used, accounts for about 10% to about 15%, by weight of the total composition.

In the present invention, the food-grade additives may comprise up to about 60% by weight, based on the total weight of the composition. Preferably, the additives comprise from about 5% to about 40% by weight, based on the total weight of the composition.

As used herein, “gas-releasing system” means any food-grade composition that releases gas bubbles when added to a foodstuff, e.g., an aqueous food or beverage, or other ingestible liquid, such as, an orally administered medicine. In the present invention, a gas-releasing system may include, e.g., a carbonate and an acid or a bicarbonate and an acid. The carbonate and/or bicarbonate contribute to the fizz or agitation of the foodstuff, as well as effect pH level.

In the present invention, the bicarbonate includes any food-grade form of bicarbonate, such as, for example, sodium bicarbonate, calcium bicarbonate, potassium bicarbonate, salts, derivatives, and combinations thereof. Preferably, the bicarbonate is sodium bicarbonate.

In the present invention, the acid may be a food-grade organic acid. Food-grade organic acids useful in the present invention include, for example, citric acid, malic acid, succinic acid, butyric acid, fumaric acid, tartaric acid, sorbic acid, adipic acid, salts, derivatives, and combinations thereof. Preferably, the acid is citric acid, malic acid, and combinations thereof. In the present invention, when a mixture of citric acid and malic is used as the organic acid, it is preferred that the citric acid and malic acid be present in a ratio, by weight, of about 1: about 1.

The amount of carbonate or bicarbonate and acid used in the present compositions is sufficient to cause the tablet to rise, be agitated, and dispersed, but unlike effervescent antacid formulations, insufficient to cause significant buffering of gastric acids. Preferably, the gas releasing system has a molar excess of acid compared to the carbonate or bicarbonate to avoid an unpleasant buffering taste. In the present compositions, it is also possible that the ratio, by weight, of the carbonate or bicarbonate to acid is less than or equal to about 1: about 1. Such a ratio produces a vigorous agitation when added to an aqueous foodstuff, e.g., a beverage or an orally administered medicine.

Food-grade organic acids balance the pH and increase the effect of the carbonate or bicarbonate so that the final sweetened foodstuff is acidic. The food-grade organic acids of the present invention also affect the flavor profile when, for example, fruit flavors, particularly citrus flavors, are present. For example, citric acid provides an initial tart fruit flavor, while malic acid produces a longer lasting flavor that is less intense. The two may be mixed to produce a more desirable flavor. The addition of the acid to the carbonate or bicarbonate also increases the level of gas released.

Gas-releasing systems useful in the present invention include the following:

| Formulation | Bicarbonate | Acid |
|---|---|---|
| 1 | Sodium Bicarbonate | Citric Acid |
| 2 | Sodium Bicarbonate | Malic Acid |
| 3 | Sodium Bicarbonate | Citric Acid + Malic Acid |

The compositions of the present invention may contain from about 0.001% to about 10% by weight of at least one sweetener based on the total weight of the composition. Preferably, the compositions of the present invention may contain from about 0.01% to about 5% by weight of at least one sweetener based on the total weight of the composition.

Compositions of the present invention may contain from about 5% to about 95% by weight of the gas-releasing system based on the total weight of the composition. More preferably, the sweetener composition may contain from about 20% to about 80% by weight of the gas-releasing system based on the total weight of the composition. As used herein, all numerical ranges provided are intended to expressly include at least all numbers that fall between the endpoints of ranges.

An alternative means for accomplishing gas-release includes a food-grade gas be trapped or sequestered within a water-soluble food-grade polymer. In the present invention, the food-grade gas includes, for example, carbon dioxide, oxygen, argon, helium, nitrogen and combinations thereof.

The water-soluble food-grade polymers useful in the present invention include, for example, carbohydrates, gums, celluloses, soluble fibers, and combinations thereof. Preferably, the food-grade polymer is a carbohydrate matrix, such as, a low bulk density spray dried maltodextrin.

The water-soluble food-grade polymer containing trapped or sequestered gas may be combined into a tablet, cube, or other solid dosage form with a sweetener. Therefore, when the tablet or cube or other solid dosage form is contacted with a beverage or an ingestible liquid, the maltodextrin will dissolve, releasing the gas and causing mixing, fizzing, and agitation.

Generally, the sweetener composition of the present invention may be packaged for industrial or commercial use, such as in the food services industry, or for use by consumers in the same manner as other sweeteners (e.g., a unit dose quantity). A unit dose quantity for the compositions of the present invention may include, for example, a teaspoon, a quart, a cup, a pint, a liter, an ounce, a pound, a gram, 100 grams, a kilogram, or any multiple or fraction thereof, of sucrose equivalent sweetness. These packaged forms may include, for example, boxes, bags, drums, tubs, pouches, containers, jars, and the like, and individual use (i.e., unit package) forms, such as, packets or mixtures thereof (e.g., tub containing individual packets). These packaged forms may further include, for example, a container, which is further packaged in a multi-container package or a container that is over-wrapped with a secondary packing material. The compositions of the present invention may be sold to consumers individually, or as a part of a multi-container unit.

As noted above, the compositions of the present invention may be provided in a package form. Tearing the package, or removing a cap or lid from the package, as appropriate, opens the package. The package may be composed of a coated paper, folded and sealed to create a small pouch. The coating on the paper protects the material in the package from environmental conditions that may affect the product's stability and quality such as scents, moisture, oxygen, and atmospheric contaminants. Coatings that are appropriate for the compositions of the present invention are well known in the art.

Preferably, a tablet containing a composition of the present invention is packaged using conventional packaging material for single-use tablets or pills.

In view of the foregoing, it is clear that one advantage of the present invention is its effectiveness in cold beverages. In cold beverages, such as bottled water, conventional dissolving times can be very long. The mixing and rapid dissolving feature of the present invention makes the sweetener composition particularly useful for sweetening cold beverages.

Another embodiment of the present invention is a self-mixing composition that includes about 40% sodium bicarbonate by weight based on the total weight of the composition, about 40% of at least one acid by weight based on the total weight of the composition, about 8% of at least one flavor by weight based on the total weight of the composition, about 11.5% leucine by weight based on the total weight of the composition, and about 0.5% sweetener by weight based on the total weight of the composition.

In this embodiment, self-mixing refers to the ability of the composition to uniformly disperse the components of the composition into an aqueous foodstuff, e.g., a beverage or orally administered medicine, upon contact.

In this embodiment, the organic acid is malic and citric acid in equal parts by weight, the flavor is lemon and lime in equal parts by weight, and the sweetener is selected from the group consisting of a nutritive sweetener, a high intensity sweetener, and combinations thereof. Preferably, the citric acid and malic acid are present in the composition at about 20%, by weight, the flavor is about 4%, by weight, lemon flavor and about 4%, by weight, lime flavor, and the sweetener is sucralose.

Another embodiment of the present invention is a method of making a sweetener composition. The method includes combining an effective amount of sweetener with a gas-releasing system. The amount and identity of the sweetener and the gas-releasing system in this method are as described above.

In this embodiment, the combining step includes conventional techniques for combining dry ingredients, such as for example, dry mixing, spray drying, agglomeration, panning, co-crystallization, chilsonation, and the like. Once the ingredients are combined, they may be pressed into a tablet form.

As is well known, not all formulations will form a tablet when put under pressure. In such cases, any conventional binder that does not interfere with the reaction of the carbonate/bicarbonate and acid may be incorporated into the composition. There are many types of binders that can be used in tablet making. For example, leucine and lactose, alone or in combination, may be incorporated into the compositions of the present invention.

Another embodiment of the invention is a method of dispersing a composition in an aqueous foodstuff. This method includes contacting the aqueous foodstuff with a composition that includes a sweetener and a gas-releasing agent. In this embodiment, the aqueous foodstuff may be a liquid-based food, a beverage, an orally administered medicine, and the like. The identity and amounts of the sweetener(s) and gas-releasing agent(s) are as described above.

The following examples are provided to further illustrate the compositions and methods of the present invention. These examples are illustrative only and are not intended to limit the scope of the invention in any way.

### EXAMPLES

### Example 1

Comparison Antacid Formulation In Water

An original version ALKA SELTZER® brand antacid tablet (Bayer Health Care, Morristown, N.J.) tablet (2.90g) is dropped into 300 ml of mineral water. According to the manufacturer, each tablet contains 1.7 g sodium carbonate and 1.0 g citric acid. Before the tablet is added, the pH of the mineral water is determined to be 6.42. After the tablet dissolves in the mineral water, the pH of the water is 6.02. Another tablet is added to the solution and the pH is determined to be 6.09.

### Example 2

Comparison Antacid Formulation In Citric Acid

An antacid tablet as described in Example 1 is dropped into 300 ml of a citric acid solution. Before the tablet is added, the pH of the citric acid solution is determined to be 2.52. After the tablet dissolves, the pH of the citric acid solution is determined to be 4.23. Another tablet is added to the citric acid solution and the pH is determined to be 4.92.

Examples 1 and 2 show the buffering action of the antacid tablet.

### Example 3

Sweetener Tablet Formulation And Methodology

The objectives of this experiment are to produce tablets, containing sucralose that, when added to water, give flavor, sweetness, and a mildly carbonated, acidic final product. Different compositions of the present invention are created and evaluated, which vary in types of flavors, food acids, carbonates and/or bicarbonates used. The finished compositions are assessed based on flavor, sweetness, level of carbonation, and solubility in water. Once a final product is chosen, then it is made into 0.4 g tablets.

A standard size for a glass of water is approximately 300 ml. After some experimentation using the 0.4 g tablets having carbonate and acid combinations, it is determined that a larger quantity of powder is required to produce any significant amount of fizz in this standard serving of water.

Accordingly, 5 g samples of powder are added to 300 ml water. This is assessed for flavor, fizz, sweetness, acidity, and ability to form a tablet. Small tablets, e.g., less than or equal to 0.4 g, are manufactured, and a total of 5 g of powder are added to the 300 ml of water as multiple tablets.

Sweetness: 0.3% sucralose is deemed the optimum sweetness level.

Carbonation: None of the carbonates or bicarbonates tested produce a significant fizz when added to water alone. About a 50:50 carbonate:acid ratio produces a strong fizz when dropped into the glass of water.

Sodium carbonate and sodium bicarbonate produce a greater fizzing effect than potassium carbonate and potassium bicarbonate. No difference in taste is perceived. Combinations of carbonates are also evaluated. The greatest fizz comes from using sodium bicarbonate and citric acid.

Food acid: In terms of initial fizz, the citric acid is the better food acid. However, the addition of malic acid produces a more rounded, longer lasting flavor, regardless of the flavor used. The effervescence lasts longer with this combination of acids.

The 50:50 carbonate or bicarbonate to acid ratio is also deemed optimal because less acid gives a slightly salty, antacid flavor to the drink. The greater the amount of carbonate or bicarbonate and acid added, the better the fizz. Accordingly, the quantity of other components of the tablet is first determined and the rest of the composition is made up of carbonate or bicarbonate and an acid.

Binder: Despite an initial formula containing leucine and lactose, it is determined that leucine alone forms better tablets. This has the added advantage of reducing the possibility of any Maillard browning occurring. Between 10 and 15% leucine is needed for the powder to bind.

Flavor: Once the rest of the components of the tablets are decided upon, flavors may be incorporated into the formulas. The citrus flavors are slightly less strong and levels of approximately 8% are optimal to give the resulting drink a good, fruity flavor. A cranberry flavor is more detectable at lower levels. A mixture of lemon and lime flavor produces the best overall flavor.

The final formula is decided upon as sodium bicarbonate (40%), citric acid (20%), malic acid (20%), lemon flavor (4%) (Firmenich 501.050/AP 05.51; Plainsboro, N.J.), lime flavor (4%) (Firmenich 501.054/TP 05.51; Plainsboro, N.J.), Leucine (11.7%), and Sucralose (0.3%).

A 100 g sample of a powdered composition of the present invention is produced by dry mixing the ingredients as shown in Table 1. The powder is then pressed into 0.4 g tablets.

TABLE 1
Sweetener Composition

| Component | Name | Amount (g) |
|---|---|---|
| Bicarbonate | Sodium bicarbonate | 40 |
| Acid | Citric Acid | 20 |
| | Malic acid | 20 |
| Flavor | Lemon | 4 |
| | Lime | 4 |
| Binder | Leucine | 11.7 |
| Sweetener | Sucralose | 0.3 |
| Total | | 100 |

A total of 5 g of the above-referenced formula is placed in 300 ml of water. The water alone has a pH of 6.55. When 5 g of the above-referenced formula is added to 300 ml of water, the pH drops to 5.04. This formula works best for a balance of sweetness, flavor, carbonation, and acidity. Moreover, this formulation is easily formed into tablets. A 0.4 g tablet takes approximately 1 minute to fully dissolve when left in a 300 ml glass of water at room temperature.

More than one 0.4 g tablet is needed to get these attributes in a 300 ml glass of water. While a 5 g mixture is used in this experimentation, less than 5 g still produces an acceptable drink. For example, four 0.4 g tablets dropped into a 150 ml glass of water produces an acceptable drink. If the use of a single tablet is desired then a larger tablet size may be utilized.

Thus, tablets and powders containing the inventive formulation from Table 1 produce an acceptable drink without the need for stirring.

### Example 4

One, Three, and Five Gram Tablets

A 100 g sample of a powdered composition from Example 3 is made by dry mixing the components. The powder is then pressed into 1 g, 3 g, and 5 g tablets using a tablet press.

One, three and five gram tablets are added to three separate glasses containing 300 ml of water, respectively. The tablets are then assessed for flavor, fizz, sweetness, and acidity. The 5 g tablet produces the most acceptable taste in 300 ml of water, followed by the 3 g tablet and the 1 gram tablet, respectively.

The scope of the present invention is not limited by the description, examples and suggested uses herein and modifications can be made without departing from the spirit of the invention. Thus, it is intended that the present invention cover modifications and variations of this invention provided that they come within the scope of the appended claims and their equivalents.

What is claimed is:

1. A self-mixing composition comprising an effective amount of a sweetener and a gas-releasing system.

2. The composition according to claim 1, wherein the sweetener is a nutritive sweetener or a high intensity sweetener.

3. The composition according to claim 1, wherein the sweetener is selected from the group consisting of sucralose, sucrose, fructose, tagatose, glucose, sugar alcohols, aspartame, acesulfame, saccharine, cyclamate, neotame, brazzein, stevia, salts, derivatives, and combinations thereof.

4. The composition according to claim 3, wherein the sweetener is sucralose.

5. The composition according to claim 3, wherein the sugar alcohols are selected from the group consisting of mannitol, sorbitol, lactitol, isomalt, erythritol, xylitol, maltitol, hydrogenated isomaltulose, hydrogenated starch hydrolyzates, and combinations thereof.

6. The composition according to claim 1, wherein the gas-releasing system comprises a carbonate and an acid.

7. The composition according to claim 1, wherein the gas-releasing system comprises a bicarbonate and an acid.

8. The composition according to claim 7, wherein the bicarbonate is selected from the group consisting of sodium bicarbonate, calcium bicarbonate, potassium bicarbonate, and combinations thereof.

9. The composition according to claims 6 or 7, wherein the acid is a food-grade organic acid.

10. The composition according to claim 9, wherein the acid is present in the composition in a molar excess compared to the carbonate or bicarbonate.

11. The composition according to claim 9, wherein the acid is selected from the group consisting of citric acid, malic acid, succinic acid, butyric acid, fumaric acid, tartaric acid, sorbic acid, adipic acid, salts, derivatives, and combinations thereof.

12. The composition according to claim 10, wherein the acid is citric acid, malic acid, and combinations thereof.

13. The composition according to claim 7, wherein the bicarbonate is sodium bicarbonate and the acid is citric acid.

14. The composition according to claim 7, wherein the bicarbonate is sodium bicarbonate and the acid is malic acid.

15. The composition according to claim 7, wherein the bicarbonate is sodium bicarbonate and the acid is citric acid and malic acid.

16. The composition according to claim 1, wherein the effective amount of sweetener provides more than about 0.5 teaspoons of sucrose equivalent sweetness to an aqueous food-stuff.

17. The composition according to claim 1, wherein the composition is in a form selected from the group consisting of tablets, powders, cubes, and granules.

18. The composition according to claim 17, wherein the form is a tablet.

19. The composition according to claim 18, wherein the gas-releasing system is asymmetrically distributed within the tablet.

20. The composition of claim 1, wherein the gas-releasing system comprises a food-grade gas trapped within a water-soluble food-grade polymer.

21. The composition according to claim 20, wherein the food-grade gas is selected from the group consisting of carbon dioxide, oxygen, argon, helium, nitrogen, and combinations thereof.

22. The composition according to claim 20, wherein the food-grade polymer is selected from the group consisting of carbohydrates, gums, celluloses, soluble fibers, and combinations thereof.

23. The composition according to claim 22, wherein the carbohydrate is maltodextrin.

24. The composition according to claim 7, wherein the ratio of bicarbonate to acid is less than or equal to 1:1 by weight based on the total weight of the composition.

25. The composition according to claim 1 further comprising one or more a food-grade additives.

26. The composition according to claim 25, wherein the food-grade additives are selected from the group consisting of flavors, texture enhancers, coloring agents, bulking agents, aroma components, binders, and combinations thereof.

27. The composition according to claim 26, wherein the food-grade additive is an aroma component.

28. The composition according to claim 27, wherein the aroma component is selected from the group consisting of essential oils, expressed oils, distilled oils, extracts, anethole, anisole, benzaldehyde, benzyl alcohol, camphor, cinnamaldehyde, citral, ethyl butanoate, d-limonene, eugenol, furaneol, furfural, linalool), menthol, methyl butanoate, methyl salicylate, neral, nerolin, pentyl butanoate, pentyl pentanoate, sotolon, strawberry ketone, 2-ethoxy-3-isopropylpyrazine, 2-methoxy-3-sec-butylpyrazine, 2-methoxy-3-methylpyrazine, thujone, thymol, trimethylamine, vanillin, salts, derivatives and combinations thereof.

29. The composition according to claim 28, wherein the aroma component is selected from the group consisting of essential oils, expressed oils, distilled oils, extracts, benzaldehyde, d-linonene, furfural, menthol, methyl butanoate, pentyl butanoate, salts, derivatives, and combinations thereof.

30. The composition according to claim 26, wherein the food-grade additive is a food-grade coloring agent.

31. The composition according to claim 30, wherein the food-grade coloring agent is selected from the group consisting of FD&C Blue No. 1 (Brilliant Blue), FD&C Blue No. 2 (Indigotine), FD&C Green No. 3 (Fast Green), FD&C Red No. 3 (Erythrosine), FD&C Red No. 40 (Allura Red), FD&C Yellow No. 5 (Tartrazine), FD&C Yellow No. 6 (Sunset Yellow), annatto extract, anthocyanis, aronia/redfruit, beet juice, beet powder, beta-carotene, beta-apo-8-carotenal, black currant, burnt sugar, canthaxanthin, caramel, carbo medicinalis, carmine, carmine/beta-carotene, carmine blue, carminic acid, carrot, carrot oils, chlorophyll, chlorophyllin, cochineal extract, copper-chlorophyll, copper-chlorophyllin, curcumin, curcumin/Cu-chlorophyllin, elderberry, grape, grape skin extracts, hibiscus, lutein, mixed carotenoids, paprika, paprika extract, paprika oleoresin, riboflavin, saffron, spinach, stinging nettle, titanium dioxide, turmeric, and combinations thereof.

32. A tablet comprising the composition of claim 1.

33. A self-mixing composition comprising:
(a) about 40% sodium bicarbonate by weight based on the total weight of the composition;
(b) about 40% of at least one acid by weight based on the total weight of the composition;
(c) about 8% of at least one flavor by weight based on the total weight of the composition;
(d) about 11.7% leucine by weight based on the total weight of the composition; and
(e) about 0.3% sweetener by weight based on the total weight of the composition.

34. The composition according to claim 33, wherein the organic acid is malic and citric acid in equal parts by weight.

35. The composition according to claim 33, wherein the flavor is lemon and lime in equal parts by weight.

36. The composition according to claim 33, wherein the sweetener is selected from the group consisting of a nutritive sweetener, a high intensity sweetener, and combinations thereof.

37. The composition according to claim 33, wherein the sweetener is sucralose.

38. A method of making a sweetener composition comprising combining an effective amount of a sweetener with a gas-releasing system.

39. The method according to claim 38 further comprising forming the composition into a tablet.

40. A method of dispersing a composition in an aqueous foodstuff comprising contacting the aqueous foodstuff with a composition comprising a sweetener and a gas-releasing system.

41. The method according to claim 40, wherein the sweetener is a nutritive sweetener or a high intensity sweetener.

42. The method according to claim 40, wherein the sweetener is selected from the group consisting of sucralose, sucrose, fructose, tagatose, glucose, sugar alcohols, aspartame, acesulfame, saccharine, cyclamate, neotame, brazzein, stevia, salts, derivatives, and combinations thereof.

43. The method according to claim 42, wherein the sweetener is sucralose.

44. The method according to claim 42, wherein the sugar alcohols are selected from the group consisting of mannitol, sorbitol, lactitol, isomalt, erythritol, xylitol, maltitol, hydrogenated isomaltulose, hydrogenated starch hydrolyzates, and combinations thereof.

45. The method according to claim 40 further comprising one or more a food-grade additives.

46. The method according to claim 45, wherein the food-grade additives are selected from the group consisting of flavors, texture enhancers, coloring agents, bulking agents, aroma components, and combinations thereof.

47. The method according to claim 46, wherein the food-grade additive is an aroma component.

48. The method according to claim 47, wherein the food-grade additive is an coloring agent.
